(19) United States
(12) Patent Application Publication
(10) Pub. No.: US 2024/0330739 A1
(43) Pub. Date: Oct. 3, 2024

(54) MACHINE LEARNING FRAMEWORK FOR TAXONOMY GRAPH CONSTRUCTION

(71) Applicant: Microsoft Technology Licensing, LLC, Redmond, WA (US)

(72) Inventors: Shiyong Lin, Manhasset, NY (US); Yi Pan, Palo Alto, CA (US); Yiping Yuan, Los Altos, CA (US); Shuang Jin, San Jose, CA (US)

(21) Appl. No.: 18/126,883

(22) Filed: Mar. 27, 2023

(51) Int. Cl. G06N 20/00

(52) U.S. Cl. CPC G06N 20/00

(57) ABSTRACT

In some embodiments, a computer-implemented method for constructing a taxonomy graph using a machine learning framework comprises preparing target data comprising target entity pairs, target entity features, and target context features, each target entity pair comprising a first target entity and a second target entity, the target context feature comprising a target sentence embedding of a target sentence that includes the first target entity and the second target entity, the preparing of the target data comprising: for each target entity pair, including the target entity pair in the target data based on a determination that the first target entity and the second target entity of the target entity pair are present in the target sentence; and generating a target taxonomy graph using a trained classification model, the target taxonomy graph comprising a hierarchical structure, the generating the target taxonomy graph comprising inputting the target data into the trained classification model.

### TECHNICAL FIELD

The present application relates generally to implementing and using a machine learning framework for constructing a taxonomy graph.

### BACKGROUND

A taxonomy graph is a graph data structure that stores different pieces of data along with their relationships to other data in a hierarchical structure. Each piece of data may correspond to a different entity and be represented in the taxonomy by a node, while the relationships between the entities may be represented by edges connecting the nodes. Online service providers, such as social networking services, e-commerce and marketplace services, photo sharing services, job hosting services, educational and learning services, and many others, may use taxonomy graphs to identify relationships between entities when providing online services to their user.

However, constructing a taxonomy graph that accurately and efficiently represents the relationships between all entities that are relevant to certain online service providers is difficult, as processing the huge amounts of data for every single permutation of pairs of entities results in an extremely large workload for the underlying computer system. Additionally, other technical problems may arise as well, as will be discussed in further detail below.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating functional components of an online service, in accordance with an example embodiment.

FIG. 2 is a block diagram illustrating functional components of a graph construction component, in accordance with an example embodiment.

FIG. 3 illustrates a data preparation pipeline, in accordance with an example embodiment.

FIG. 4 illustrates a transformer architecture, in accordance with an example embodiment.

FIG. 5 illustrates another transformer architecture, in accordance with an example embodiment.

FIG. 6 is a block diagram illustrating a classification model, in accordance with an example embodiment.

FIG. 7 is a flowchart illustrating a method of implementing a machine learning framework for constructing a taxonomy graph, in accordance with an example embodiment.

FIG. 8 is a block diagram illustrating a software architecture, in accordance with an example embodiment.

FIG. 9 illustrates a diagrammatic representation of a machine in the form of a computer system within which a set of instructions may be executed for causing the machine to perform any one or more of the methodologies discussed herein, in accordance with an example embodiment.

### DETAILED DESCRIPTION

### I. Overview

In the following description, for purposes of explanation, numerous specific details are set forth in order to provide a thorough understanding of example embodiments. It will be evident, however, to one skilled in the art that the present embodiments may be practiced without these specific details.

The above-discussed technical problems of accuracy and efficiency in constructing a taxonomy graph are addressed by one or more example embodiments disclosed herein, in which a specially-configured computer system is configured to train a classification model using training data that comprises a plurality of reference entity pairs, a label for each reference entity pair in the plurality of reference entity pairs, reference entity features for each reference entity pair in the plurality of reference entity pairs, and a reference context feature for each reference entity pair in the plurality of reference entity pairs. Each reference entity pair in the plurality of reference entity pairs may comprise a first reference entity and a second reference entity, and the reference entity features may comprise a first reference embedding of the first reference entity and a second reference embedding of the second reference entity. The reference context feature may comprise a reference sentence embedding of a reference sentence that includes the first reference entity and the second reference entity.

In some example embodiments, the computer system is configured to generate a target taxonomy graph using the trained classification model by inputting target data into the trained classification model. The target data may comprise a plurality of target entity pairs, target entity features for each target entity pair in the plurality of target entity pairs, and a target context feature for each target entity pair in the plurality of target entity pairs. Each target entity pair in the plurality of target entity pairs may comprise a first target entity and a second target entity, and the target entity features may comprise a first target embedding of the first target entity and a second target embedding of the second target entity. The target context feature may comprise a target sentence embedding of a target sentence that includes the first target entity and the second target entity. The computer system may use the target taxonomy graph in an application of an online service.

By training the classification model using a combination of the reference entity features and the reference context features, the computer system improves the ability of the classification model to determine relationships between entities and generate the target taxonomy graph. In some example embodiments, the computer system uses a seed taxonomy graph to extract positive and negative examples of entity pairs for inclusion in the training data. The computer system may use the type of relationship between the first and second reference entities in the seed taxonomy graph to classify each entity pair in the training data as either a positive example or a negative example, such as by classifying the entity pair as a positive example if there is a parent-child relationship between the first and second reference entities and classifying the entity pair as a negative example if there is not a parent-child relationship between the first and second reference entities. Parent-child relationships are the most useful relationships for building a taxonomy graph, since these types of relationships connect one entity directly with another entity without any inference having to be made to bridge the gap between the two entities. For example, when building a taxonomy graph, even if the computer system knows that two entities are siblings, the computer system does not necessarily know the identity of the entity that is the parent of the sibling entities, meaning that the identification of the sibling relationship does not necessarily result in a connection being made in the taxonomy graph. As a result, further processing of other entities may be needed to extend the taxonomy graph by one more edge. Other non-parent-child relationships, such as grandparent-grandchild relationships, suffer from the same problem. In contrast, each parent-child relationship that is identified by the computer system can be used to extend the taxonomy graph by another edge that connects the parent entity to the child entity. Therefore, by conditioning the classification of a reference entity pair as a positive example on the first reference entity and the second reference entity of the reference entity pair having a parent-child relationship or a child-parent relationship, the target taxonomy graph is built faster, as the classification model that is used to build the target taxonomy graph is trained to identify the most useful entity pairs for adding an edge to the target taxonomy graph.

Additionally, processing each and every combination of entity pairs in the generating of the target taxonomy graph may overload the computer system. In some example embodiments, the computer system includes each target entity pair in the target data that is fed into the trained classification model based on a determination that the first target entity and the second target entity of the target entity pair are present in the same target sentence. By requiring that the first target entity and the second target entity be present in the same sentence in order for them to be included in the target data that is processed by the classification model, the computer system avoids processing entity pairs that are unlikely to be related, thereby reducing the workload and improving the efficiency of the computer system.

Furthermore, in some instances, the computer system may lack access to readily available sentences that include the entity pairs. In some example embodiments, the computer system is configured to combine the entities identified from the seed taxonomy graph with descriptions of the entities to automatically generate reference sentences, thereby increasing the training data and improving the quality of the training of the classification model.

The term “reference” is used herein to indicate data and entities being used or involved in the training of the classification model. The term “target” is used herein to indicate data and entities being used or involved in the use of the trained classification model.

### II. Detailed Example Embodiments

The methods or embodiments disclosed herein may be implemented as a computer system having one or more components implemented in hardware or software. For example, the methods or embodiments disclosed herein may be embodied as instructions stored on a machine-readable medium that, when executed by one or more hardware processors, cause the one or more hardware processors to perform the instructions.

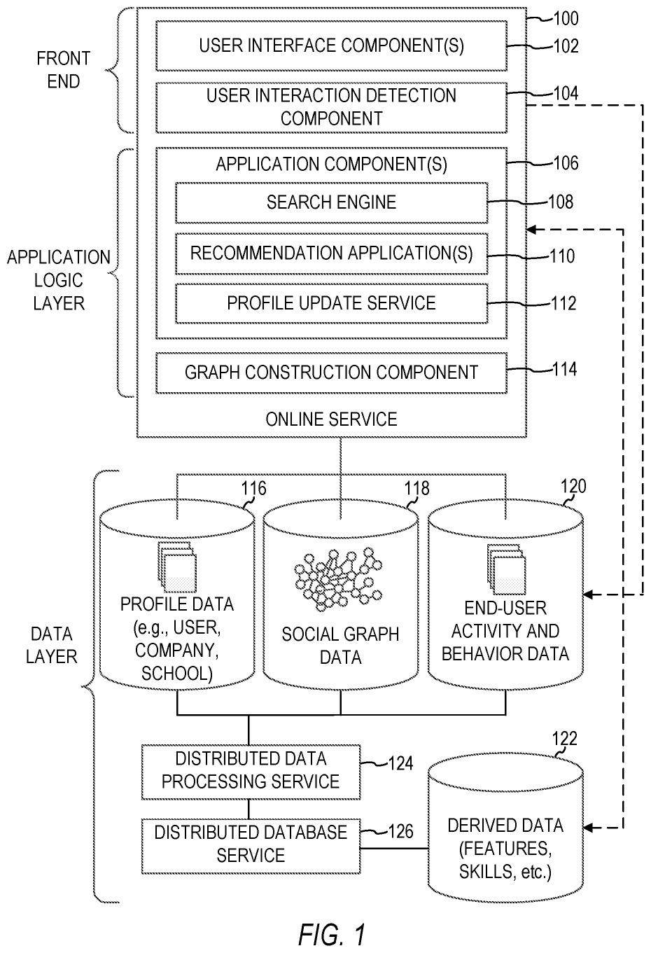

FIG. 1 is a block diagram illustrating functional components of an online service 100, in accordance with an example embodiment. As shown in FIG. 1, a front end may comprise one or more user interface components (e.g., a web server) 102, which receives requests from various client computing devices and communicates appropriate responses to the requesting client devices. For example, the user interface component(s) 102 may receive requests in the form of Hypertext Transfer Protocol (HTTP) requests or other web-based API requests. In addition, a user interaction detection component 104, sometimes referred to as a click tracking service, may be provided to detect various interactions that end-users have with different applications and services, such as those included in the application logic layer of the online service 100. As shown in FIG. 1, upon detecting a particular interaction, the user interaction detection component 104 logs the interaction, including the type of interaction and any metadata relating to the interaction, in an end-user activity and behavior database 120. Accordingly, data from this database 120 can be further processed to generate data appropriate for training one or more machine-learned models, and in particular, for training models to rank a set of skills for an end-user.

An application logic layer may include one or more application server components 106, which, in conjunction with the user interface component(s) 102, generate various user interfaces (e.g., web pages) with data retrieved from various data sources in a data layer. Consistent with some embodiments, individual application server components 106 implement the functionality associated with various applications and/or services provided by the online service 100. For instance, as illustrated in FIG. 1, the application logic layer includes a variety of applications and services to include a search engine 108, one or more recommendation applications 110 (e.g., a job recommendation application, an online course recommendation application), and a profile update service 112. The various applications and services illustrated as part of the application logic layer are provided as examples and are not meant to be an exhaustive listing of all applications and services that may be integrated with and provided as part of the online service 100. For example, although not shown in FIG. 1, the online service 100 may also include a job hosting service via which end-users submit job postings that can be searched by end-users, and/or recommended to other end-users by the recommendation application(s) 110. As end-user's interact with the various user interfaces and content items presented by these applications and services, the user interaction detection component 104 detects and tracks the end-user interactions, logging relevant information for subsequent use.

As shown in FIG. 1, the data layer may include several databases, such as a profile database 116 for storing profile data, including both end-user profile data and profile data for various organizations (e.g., companies, schools, etc.). Consistent with some embodiments, when a person initially registers to become an end-user of the online service, the person will be prompted by the profile update service 112 to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 116. Similarly, when a representative of an organization initially registers the organization with the online service 100, the representative may be prompted to provide certain information about the organization. This information may be stored, for example, in the profile database 116, or another database (not shown).

Once registered, an end-user may invite other end-users, or be invited by other end-users, to connect via the online service 100. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following will appear in the end-user's personalized feed, sometimes referred to as a content feed or news feed. In any case, the various associations and relationships that the end-users establish with other end-users, or with other entities (e.g., companies, schools, organization) and objects (e.g., metadata hashtags (“#topic”) used to tag content items), are stored and maintained within a social graph in a social graph database 118.

As end-users interact with the various content items that are presented via the applications and services of the online service 100, the end-users' interactions and behaviors (e.g., content viewed, links or buttons selected, messages responded to, job postings viewed, etc.) are tracked by the user interaction detection component 104, and information concerning the end-users' activities and behaviors may be logged or stored, for example, as indicated in FIG. 1 by the end-user activity and behavior database 120.

Consistent with some embodiments, data stored in the various databases of the data layer may be accessed by one or more software agents or applications executing as part of a distributed data processing service 124, which may process the data to generate derived data. The distributed data processing service 124 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 124 may ingest and process data from the data layer for the purpose of generating training data for use in training various machine-learned models, and for use in generating features for use as input to the trained models. For instance, profile data, social graph data, and end-user activity and behavior data, as stored in the databases of the data layer, may be ingested by the distributed data processing service 124 and processed to generate data properly formatted for use as training data for training machine-learned models for constructing a taxonomy graph of entities. Once the derived data and features are generated, they are stored in a database 122, where such data can easily be accessed via calls to a distributed database service 124.

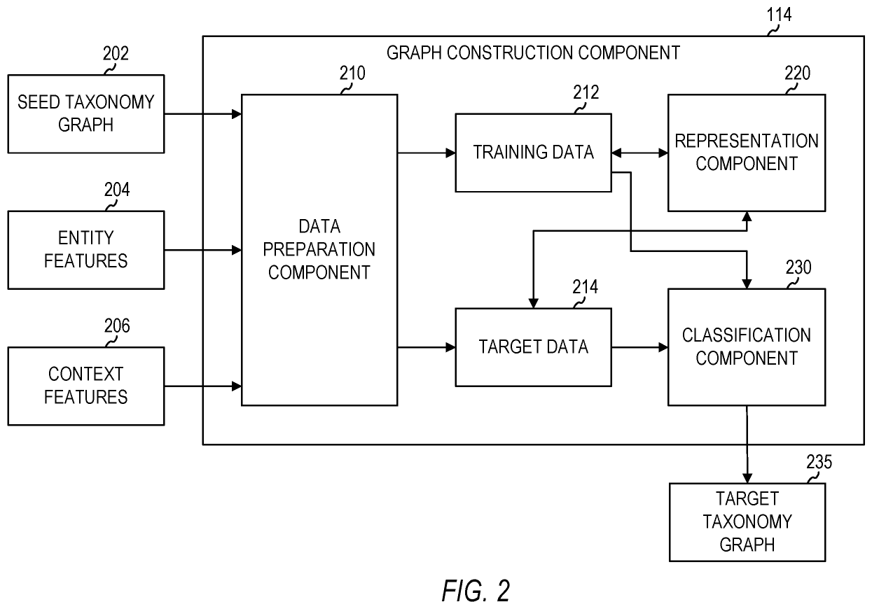

In some example embodiments, the application logic layer of the online service 100 also comprises a graph construction component 114 that is configured to implement a machine learning framework for constructing a target taxonomy graph, as will be discussed in further detail below. FIG. 2 is a block diagram illustrating functional components of the graph construction component 114, in accordance with an example embodiment. In some example embodiments, the graph construction component 114 comprises a data preparation component 210, a representation component 220, and a classification component 230.

The data preparation component 210 is configured to prepare training data 212 for use in training a classification model by the classification component 230. The data preparation component 210 is also configured to prepare target data 214 for use in generating a target taxonomy graph 235 by the classification component 230 using the trained classification model. The training data 212 and the target data 214 may comprise the same types of data, except for the training data 212 including training data labels and the target data 214 excluding training data labels.

In some example embodiments, the training data 212 comprises a plurality of reference entity pairs, a label for each reference entity pair in the plurality of reference entity pairs, reference entity features 204 for each reference entity pair in the plurality of reference entity pairs, and a reference context feature 206 for each reference entity pair in the plurality of reference entity pairs. Each reference entity pair in the plurality of reference entity pairs comprises a first reference entity and a second reference entity. The label identifies a type of relationship between the first reference entity and the second reference entity.

In some example embodiments, the first reference entity and the second reference entity comprise the same type of entity, such as the first reference entity comprising a first reference skill and the second reference entity comprising a second reference skill. In other example embodiments, the first reference entity and the second reference entity comprise different types of entities, such as the first reference entity comprising a first type of entity and the second reference entity comprising a second type of entity that is different from the first type of entity. In one example, the first reference entity comprises a skill (e.g., “Machine Learning”) and the second reference entity comprises an education degree (e.g., “Computer Science”). In another example, the first reference entity comprises a skill (e.g., “Machine Learning”) and the second reference entity comprises an industry (e.g., “Information Technology Services”). Other combinations of entity types are also within the scope of the present disclosure.

The data preparation component 210 is configured to obtain a seed taxonomy graph 202 of the online service 100. The seed taxonomy graph 202 comprises a hierarchical graph representing the relationships between entities of the online service 100. The seed taxonomy graph is a subgraph of the target taxonomy graph that is to be built by the graph construction component 114, such that the seed taxonomy does not include all of the entities of the online service 100, but rather includes only a subset of all of the entities of the online service. For example, if the target taxonomy graph is to represent a taxonomy of skills for the online service and the taxonomy of skills comprises 40,000 skills, the seed taxonomy graph only includes a subset of those 40,000 skills (e.g., 1,000 skills) rather than all 40,000 skills. The entities may all be of the same type. For example, the entities may all be skills. Alternatively, the seed taxonomy graph 202 may comprise entities of different types. For example, the seed taxonomy graph 202 may comprise entities that are skills, profile titles, education degrees, industries, and interests. Other types of entities are also within the scope of the present disclosure. The seed taxonomy graph 202 may be constructed by one or more humans and then stored in a database of the online service 100, such as in the database 122, for access and retrieval by the graph construction component 114.

In some example embodiments, the data preparation component 210 extracts positive examples and generates negative examples from the seed taxonomy graph 202 for use as training data 212. For example, the data preparation component 210 may extract the plurality of reference entity pairs from the seed taxonomy graph 202 of the online service 100. Each reference entity pair may comprise a first reference entity and a second reference entity. For each reference entity pair in the plurality of reference entity pairs, the data preparation component 210 may assign a label for the reference entity pair based on the type of relationship (e.g., parent-child, siblings, grandparent-grandchild) between the first reference entity and the second reference entity of the reference entity pair. For each reference entity pair in the plurality of reference entity pairs, the data preparation component 210 classifies the reference entity pair as a positive example if the type of relationship between the first reference entity and the second reference entity of the reference entity pair comprises a parent-child relationship or a child-parent relationship, and classifies the reference entity pair as a negative example if the type of relationship between the first reference entity and the second reference entity of the reference entity pair does not comprise a parent-child relationship or a child-parent relationship, such as if the relationship between the first reference entity and the second reference entity is a sibling relationship or a grandparent-grandchild relationship.

Parent-child and child-parent relationships are the most useful relationships for building a taxonomy graph, since these types of relationships connect one entity directly with another entity without any inference having to be made to bridge the gap between the two entities. For example, when building a taxonomy graph, even if the computer system knows that two entities are siblings, the computer system does not necessarily know the identity of the entity that is the parent of the sibling entities, meaning that the identification of the sibling relationship does not necessarily result in a connection being made in the taxonomy graph. As a result, further processing of other entities may be needed to extend the taxonomy graph by one more edge. Other non-parent-child relationships, such as grandparent-grandchild relationships, suffer from the same problem. In contrast, each parent-child relationship that is identified by the computer system can be used to extend the taxonomy graph by another edge that connects the parent entity to the child entity. Therefore, by conditioning the classification of a reference entity pair as a positive example on the first reference entity and the second reference entity of the reference entity pair having a parent-child relationship or a child-parent relationship, the target taxonomy graph is built faster, as the classification model that is used to build the target taxonomy graph is trained to identify the most useful entity pairs for adding an edge to the target taxonomy graph.

The data preparation component 210 may include reference entity pairs in the training data 212 based on a determination that a number of the reference entity pairs in the training data 212 that are classified as negative examples compared to a number of the reference entity pairs in the training data 212 that are classified as positive examples satisfies a balanced data criteria. For example, the balanced data criteria may require that the number of reference entity pairs in the training data 212 that are classified as negative examples is at least 75% of the number of reference entity pairs in the training data 212 that are classified as positive examples or that there are equal numbers of negative examples as positive examples in the training data 212, thereby ensuring that there is a sufficient number of negative examples in the training data 212 to balance out the positive examples.

In some example embodiments, the reference entity features 204 comprise a first reference embedding of the first reference entity and a second reference embedding of the second reference entity. The first reference embeddings and the second reference embeddings may each comprise a vector representation of their corresponding entity. These vector representations may be computed using an unsupervised learning algorithm. For example, the vector representations of the entities may be computed using Global Vectors for Word Representation (GloVe). The reference embeddings may be computed using other algorithms as well.

In some example embodiments, each reference context feature 204 comprises a reference sentence embedding of a reference sentence that includes the first reference entity and the second reference entity. The data preparation component 210 may obtain the reference sentences to be included in the training data 212 by extracting the reference sentences from online content. Such online content may include, but is not limited to, a reference job posting published on the online service 100, a reference profile published on the online service 100, a reference post of a user published on the online service 100, a reference course description published on the online service 100, a reference search query submitted to the search engine 108 of the online service 100, or a reference description of the first reference entity or the second reference entity (e.g., a description or definition of the entity published on a web page). For example, the sentence “TensorFlow is a free and open-source software library for machine learning” includes a first reference entity “TensorFlow” and a second reference entity “machine learning.”

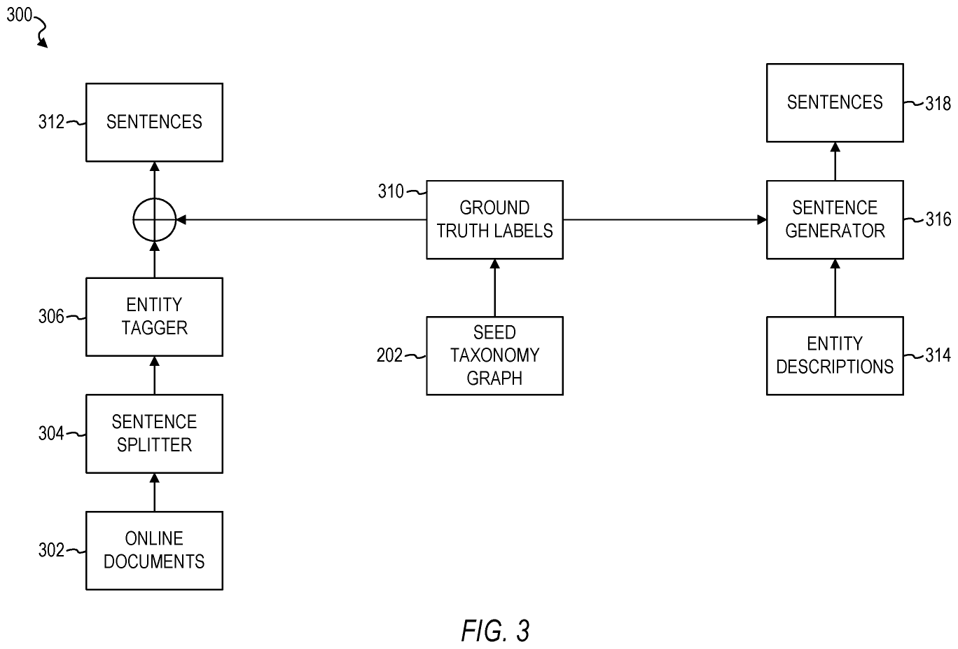

FIG. 3 illustrates a data preparation pipeline 300, in accordance with an example embodiment. This data preparation pipeline 300 may be used by the data preparation component 210 to obtain the sentences of the context features 206. In some example embodiments, the data preparation component 210 obtains text from online documents 302 (e.g., web pages and other online pages) and then uses a sentence splitter 304 to split the text into sentences 312. The data preparation component 210 may then use an entity tagger to tag the entities found in those sentences 312 and use the sentences 312 with relevant taxonomy entity pairs as context features 206.

The data preparation component 210 assigns labels to the sentences 312 using ground truth labels 310 computed using the seed taxonomy graph 202. The sentences 312 are labelled as either being a positive example or a negative example. The data preparation component 210 may use label generation rules to label the sentences. For example, the data preparation component 210 may label a sentence 312 as a positive example if the type of relationship between the first reference entity and the second reference entity included in the sentence comprises a parent-child relationship or a child-parent relationship, and may classify the reference entity pair as a negative example if the type of relationship between the first reference entity and the second reference entity of the reference entity pair does not comprise a parent-child relationship or a child-parent relationship, such as if the relationship between the first reference entity and the second reference entity is a sibling relationship or a grandparent-grandchild relationship.

In some example embodiments, the data preparation component 210 is additionally or alternatively configured to generate the reference sentences for the reference sentence embeddings to be included in the training data 212. For example, the data preparation component 210 extract descriptions 314 of the first reference entity and the second reference entity from one or more data sources, such as the database 122. The data preparation component 210 may then generate the reference sentence 318 for each reference entity pair in the plurality of reference entity pairs using the descriptions of the first reference entity and the second reference entity. The data preparation component 210 assigns labels to the sentences 318 using ground truth labels 310 computed using the seed taxonomy graph 202, such as by using the same techniques discussed above with respect to assigning labels to the sentences 312.

Referring back to FIG. 2, in some example embodiments, the representation component 220 is configured to compute the reference sentence embeddings by inputting the reference sentences 312 or 318 into a representation model of the representation component 220. A sentence embedding is a vector representation, where sentences are mapped to sequences of numbers that represent their meaning. The representation model of the representation component 220 may comprise a transformer architecture. In some example embodiments, the transformer architecture comprises a Bidirectional Encoder Representations from Transformers (BERT) model architecture.

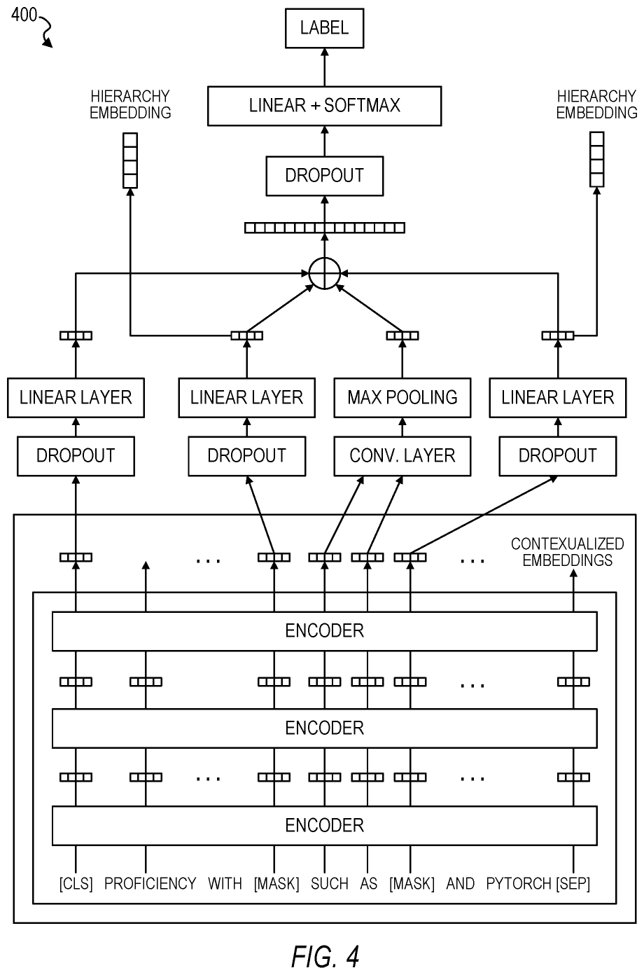

FIG. 4 illustrates a transformer architecture 400, in accordance with an example embodiment. The transformer architecture 400 uses a BERT model that takes real-world text corpuses (e.g., job postings, resumes, web pages) as raw input. The input texts are first split into individual sentences within min/max length limits, in which there are at least a pair of tagged taxonomy entities, such as by using the sentence splitter 304 and the entity tagger 306 on text from online documents 302 to generate sentences 312 as described above with respect to FIG. 3. For each entity pair occurring in a sentence, a training sample may be created by replacing the two tagged entities with special [MASK] tokens, such as by using a masked language modelling approach. In masked language modelling, some input tokens are masked with the [MASK] token and the BERT model is trained to predict the masked tokens by gathering the context of the masked tokens from the surrounding tokens, such as from tokens on the left side of the [MASK] token and from tokens on the right side of the [MASK] token. This approach helps prevent the downstream layers from only remembering the entities instead of learning the sentence contexts between them.

The training sentences are fed into the pre-trained BERT model for the taxonomy graph link prediction task. The embeddings of the two [MASK] tokens are taken from the last layer of the encoder. The transformer architecture 400 may also take the sentence [CLS] token embeddings and Max Pooling embeddings of tokens between the two [MASK] tokens. In the end, the transformer architecture 400 concatenates all four tokens as input for the classification model of the classification component 230. After the representation component 220 has successfully tuned the BERT encoder for the training task, embeddings for the two [MASK] tokens can be used as the representations of the two entities, and they may be used as input for the classification model of the classification component 230.

In some example embodiments, the classification component 230 trains the classification model to classify relationships between pairs of entities using the prepared training data. The classification model may comprise a neural network that computes probabilities of relationships between pairs of entities. The classification model may then use the computed probabilities of relationships between pairs of entities to build a target taxonomy graph 235 of entities. Other types and configurations of the classification model may be used as well.

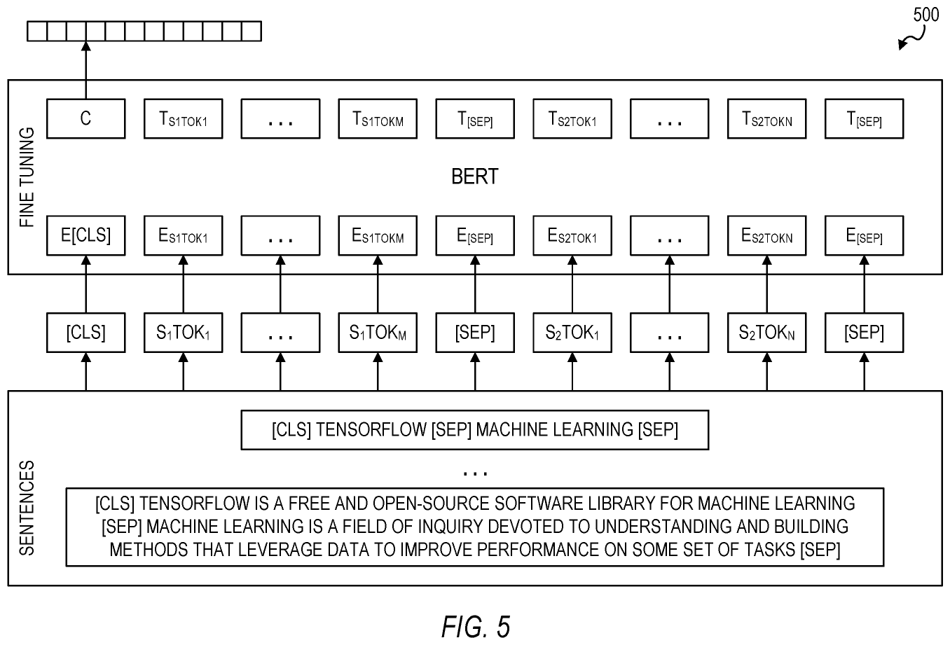

FIG. 5 illustrates another transformer architecture 500, in accordance with an example embodiment. In some example embodiments, the representation component 220 uses the transformer architecture 500 to compute the reference sentence embeddings and the target sentence embeddings. The transformer architecture 500 comprises a Knowledge Graph BERT (KG-BERT) model architecture. Input data for the KG-BERT model may comprise the sentences 318 that are synthetically generated from the seed taxonomy graph 202. The KG-BERT model represents entities and their relations by their names and descriptions, then creates a sequence by joining the two entities with special tags. These synthetically generated sentences are used as target data to fine-tune the pre-defined BERT model for predicting the entity relations. Given relation triplet xᵢ=(eᵢ^{l}, eᵢ^{r}, rᵢ), where eᵢ^{l} and eᵢ^{r} are two taxonomy entities and rᵢ is their relationship type edge, a context sentence as input to the KG-BERT model may be generated according to the following predefined rules: (a) a special classification token [CLS] is always added as the first token of the sentence; (b) entity names or descriptions or relationship are separated by a special token [SEP]; (c) the relationship is optional; and (d) sentences always end with a special token [SEP]. Table 1 below shows all four possible combinations to generate a sentence:

| nᵢ^{l} | nᵢ^{r} | context sentence |
|---|---|---|
| Name l | Name r | [CLS] Name l [SEP] Name r [SEP] |
| Name l | Description r | [CLS] Name l [SEP] Description r [SEP] |
| Description l | Name r | [CLS] Description l [SEP] Name r [SEP] |
| Description l | Description r | [CLS] Description l [SEP] Description r |
| | | [SEP] |

In one example, given that TensorFlow is a tool of Machine Learning, the representation component 220 may first find descriptions for both TensorFlow and Machine Learning. According to one online source, TensorFlow is described as “TensorFlow is a free and open-source software library for machine learning”, while Machine Learning is described as “Machine Learning is a field of inquiry devoted to understanding and building methods that leverage data to improve performance on some set of tasks. It is seen as a part of artificial intelligence.” From the rules in table 1, four contextual sentences could be generated:
(1) [CLS] TensorFlow [SEP] Machine Learning [SEP]
(2) [CLS] TensorFlow is a free and open-source software library for machine learning [SEP] Machine Learning [SEP]
(3) [CLS] TensorFlow [SEP] Machine Learning is a field of inquiry devoted to understanding and building methods that leverage data to improve performance on some set of tasks. It is seen as a part of artificial intelligence [SEP]
(4) [CLS] TensorFlow is a free and open-source software library for machine learning [SEP] Machine Learning is a field of inquiry devoted to understanding and building methods that leverage data to improve performance on some set of tasks. It is seen as a part of artificial intelligence [SEP]

The input sentences for the KG-BERT model architecture shown in FIG. 5 are fed into BERT encoder layers. The embeddings of the first classification token [CLS] from the final layer is used as the aggregated representation of the relationship between two entities.

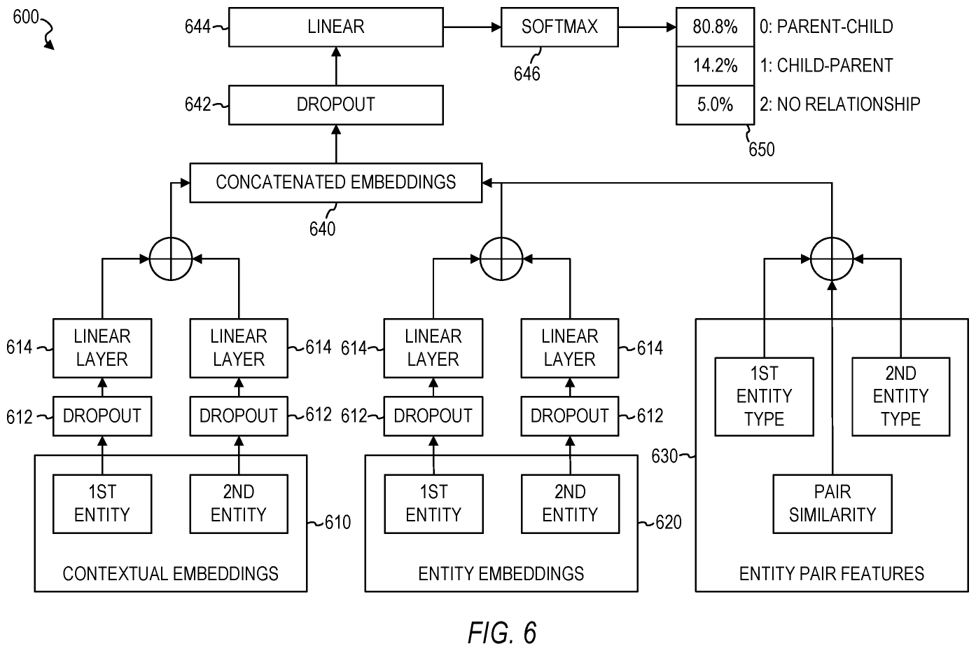

FIG. 6 is a block diagram illustrating a classification model 600, in accordance with an example embodiment. For each entity pair comprising a first entity and a second entity (reference entities when training the classification model 600 and target entities when using the classification model 600 to construct the target taxonomy graph 235), the classification model 600 uses the contextual embeddings 610 that were computed for the first and second entities by the representation component 220 along with entity embeddings 620 for the first and second entities to train a classifier to compute predictions or probabilities 650 of relationships for entity pairs, which are used by the classification component 230 to construct the target taxonomy graph 235. The entity embeddings 620 of each entity pair may each comprise a vector representation of their corresponding entity. These vector representations may be computed using an unsupervised learning algorithm. For example, the vector representations of the entities may be computed using Global Vectors for Word Representation (GloVe). The entity embeddings 620 may be computed using other algorithms as well. The classification model 600 may use standard multi-class cross entropy as the loss function.

In the classification model 600, the contextual embeddings 610 and the entity embeddings 620 are fed through a dropout layer 612 to avoid overfitting to a single type of embedding or feature, and then fed to a linear layer 614. The dropout layer 612 employs one or more regularization techniques for reducing overfitting in artificial neural networks by preventing complex co-adaptations on training data or target data. For example, the dropout layer 612 may randomly drop out or omit units (hidden and visible) during the training process. The results from the linear layer 614 are concatenated to form concatenated embeddings 640. The classification model 600 may also use entity pair features 630 of the first entity and the second entity. For example, the entity pair features 630 may comprise the corresponding type of entity for each of the first entity and the second entity. For example, the entity type for the first entity may be a skill and the entity type for the second entity may be an industry. The entity pair features 630 may also comprise a measure of similarity between the first entity and the second entity. For example, the reference entity features may comprise a cosine similarity for a first embedding of the first entity and a second embedding of the second entity. These entity pair features may also be added to the concatenated embeddings 640. The concatenated embeddings 640 are fed through another dropout layer 642 to once again randomly drop out or omit units in order to avoid overfitting. The output of the dropout layer 642 is fed to another linear layer 644, and the output of the linear layer 644 is fed to a softmax layer 646 to predict the probability of parent/child relation between two taxonomy entities. The softmax layer 646 uses a function that converts a vector of numbers of the concatenated embeddings 640 into a vector of probabilities 650, where the probabilities of each value are proportional to the relative scale of each value in the vector.

In some example embodiments, the classification component 230 uses the predicted relationships of the entities to construct the target taxonomy graph 235. For example, the classification component 230 may connect two entities in the target taxonomy graph 235 using an edge that represents the relationship with the highest predicted probability 650. These edges may be used to connect entities when the predicted relationship is a particular type of relationship, such as a parent-child relationship (e.g., the first entity is the parent and the second entity is the child) or a child-parent relationship (the first entity is the child and the second entity is the parent). When the predicted relationship between two entities does not meet the relationship type criteria, then the classification component abstains from connecting those two entities in the target taxonomy graph 235.

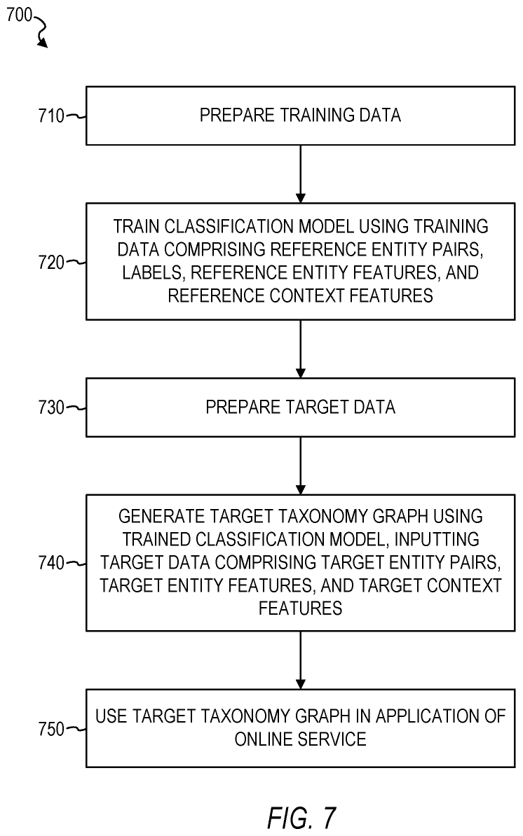

FIG. 7 is a flowchart illustrating a method 700 of implementing a machine learning framework for constructing a taxonomy graph, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the online service 100 of FIG. 1, or any combination of one or more of its components (e.g., the graph construction component 114, the application component 106), as described above.

At operation 710, the online service 100 prepares training data for use in training a classification model. In some example embodiments, the training data comprises a plurality of reference entity pairs, a label for each reference entity pair in the plurality of reference entity pairs, reference entity features for each reference entity pair in the plurality of reference entity pairs, and a reference context feature for each reference entity pair in the plurality of reference entity pairs. Each reference entity pair in the plurality of reference entity pairs comprises a first reference entity and a second reference entity. The label identifies a type of relationship between the first reference entity and the second reference entity. The reference entity features comprise a first reference embedding of the first reference entity and a second reference embedding of the second reference entity. The reference context feature comprises a reference sentence embedding of a reference sentence that includes the first reference entity and the second reference entity.

The online service 100 may obtain the reference sentences to be included in the training data by extracting the reference sentences from online content. Such online content may include, but is not limited to, a reference job posting published on the online service 100, a reference profile published on the online service 100, a reference post of a user published on the online service 100, a reference course description published on the online service 100, a reference search query submitted to a search engine of the online service 100, or a reference description of the first reference entity or the second reference entity.

Additionally or alternatively, the online service 100 may generate the reference sentences for the reference sentence embeddings to be included in the training data. For example, in some embodiments, the preparing the training data comprises extracting the plurality of reference entity pairs from a seed taxonomy graph of the online service 100, and then, for each reference entity pair in the plurality of reference entity pairs, extracting a first description of the first reference entity of the reference entity pair from a first data source and a second description of the second reference entity of the reference entity pair from a second data source, and generating the reference sentence for each reference entity pair in the plurality of reference entity pairs using the first description of the first reference entity of the reference entity pair and the second description of the second reference entity of the reference entity pair.

In some example embodiments, the online service 100 computes the reference sentence embeddings by inputting the reference sentences into a representation model. The representation model may comprise a transformer architecture. The transformer architecture may comprise a Bidirectional Encoder Representations from Transformers (BERT) model architecture, such as the transformer architecture 400 shown in FIG. 4 or the transformer architecture 500 shown in FIG. 5. Other types of architectures of the representation model are also within the scope of the present disclosure.

The online service 100 may use a seed taxonomy graph of the online service 100 to prepare the training data. For example, in some embodiments, the preparing the training data comprises extracting the plurality of reference entity pairs from the seed taxonomy graph of the online service 100, and, for each reference entity pair in the plurality of reference entity pairs, assigning the label for the reference entity pair based on the type of relationship between the first reference entity and the second reference entity of the reference entity pair. Next, the online service 100, for each reference entity pair in the plurality of reference entity pairs, classifies the reference entity pair as a positive example if the type of relationship between the first reference entity and the second reference entity of the reference entity pair comprises a parent-child relationship or a child-parent relationship, and classifies the reference entity pair as a negative example if the type of relationship between the first reference entity and the second reference entity of the reference entity pair does not comprise a parent-child relationship or a child-parent relationship.

The online service 100 then includes the plurality of reference entity pairs in the training data based on a determination that a number of the plurality of reference entity pairs that are classified as negative examples compared to a number of the plurality of reference entity pairs that are classified as positive examples satisfies a balanced data criteria. For example, the balanced data criteria may require that the number of the plurality of reference entity pairs that are classified as negative examples is at least 75% of the number of the plurality of reference entity pairs that are classified as positive examples, thereby ensuring that there is a sufficient number of negative examples in the training data to balance out the positive examples.

In some example embodiments, the first reference entity and the second reference entity comprise the same type of entity, such as the first reference entity comprising a first reference skill and the second reference entity comprising a second reference skill. In other example embodiments, the first reference entity and the second reference entity comprise different types of entities, such as the first reference entity comprising a first type of entity and the second reference entity comprising a second type of entity that is different from the first type of entity.

In some example embodiments, the reference entity features further comprise a reference measure of similarity between the first reference embedding of the first reference entity and the second reference embedding of the second reference entity. For example, the reference entity features may comprise a cosine similarity for the first reference embedding of the first reference entity and the second reference embedding of the second reference entity.

At operation 720, the online service 100 trains a classification model using the prepared training data. In some example embodiments, the classification model is configured to classify relationships between pairs of entities. In some example embodiments, the classification model comprises a neural network that computes probabilities of relationships between pairs of nodes. The classification model may then use the computed probabilities of relationships between pairs of nodes to build a taxonomy graph of entities. Other types and configurations of the classification model may be used as well.

At operation 730, the online service 100 prepares the target data. The target data comprises a plurality of target entity pairs, target entity features for each target entity pair in the plurality of target entity pairs, and a target context feature for each target entity pair in the plurality of target entity pairs. Each target entity pair in the plurality of target entity pairs comprises a first target entity and a second target entity. The target entity features comprise a first target embedding of the first target entity and a second target embedding of the second target entity. The target context feature comprises a target sentence embedding of a target sentence that includes the first target entity and the second target entity. In some example embodiments, the preparing of the target data comprises, for each target entity pair in the plurality of target entity pairs, including the target entity pair in the target data based on a determination that the first target entity and the second target entity of the target entity pair are present in a target sentence.

The online service 100 may obtain the target sentences of the target sentence embeddings to be included in the target data by extracting the target sentences from online content. Such online content may include, but is not limited to, a target job posting published on the online service 100, a target profile published on the online service 100, a target post of a user published on the online service 100, a target course description published on the online service 100, a target search query submitted to a search engine of the online service 100, or a target description of the first target entity or the second target entity.

The first target entity and the second target entity may comprise the same type of entity, such as the first target entity comprising a first target skill and the second target entity comprising a second target skill. In other example embodiments, the first target entity and the second target entity comprise different types of entities, such as the first target entity comprising a first type of entity and the second target entity comprising a second type of entity that is different from the first type of entity.

In some example embodiments, the target entity features further comprise a target measure of similarity between the first target embedding of the first target entity and the second target embedding of the second target entity. For example, the target entity features may comprise a cosine similarity for the first target embedding of the first target entity and the second target embedding of the second target entity.

At operation 740, the online service 100 generates a target taxonomy graph using the trained classification model. The target taxonomy graph may comprise a hierarchical structure. In some example embodiments, the generating the target taxonomy graph comprises inputting target data into the trained classification model. The classification model may compute probabilities of relationships between pairs of nodes, and then use the computed probabilities of relationships between pairs of nodes to build a taxonomy graph of entities.

At operation 750, the online service 100 uses the target taxonomy graph in an application of the online service 100. In some example embodiments, the using the target taxonomy graph in the application of the online service 100 comprises receiving a search query submitted by a user of the online service 100 via a computing device, where the search query comprises the first target entity of one of the plurality of target entity pairs, determining that the second target entity of the one of the plurality of target entity pairs is directly connected to the first target entity of the one of the plurality of target entity pairs in the target taxonomy graph, identifying content associated with the second target entity of the one of the plurality of target entity pairs, and displaying the identified content on the computing device as a response to the received search query. The first target entity is directly connected to the second target entity when the first target entity is connected to the second target entity via a single edge, such as in a parent-child relationship. In other example embodiments, the using the target taxonomy graph in the application of the online service 100 comprises determining that a first target entity of one of the plurality of target entity pairs is included in profile data of a user of the online service 100, determining that the second target entity of the one of the plurality of target entity pairs is directly connected to the first target entity of the one of the plurality of target entity pairs in the target taxonomy graph, identifying content associated with the second target entity of the one of the plurality of target entity pairs, and displaying the identified content on a computing device of the user. Other uses of the target taxonomy graph in the application of the online service 100 are also within the scope of the present disclosure.

It is contemplated that any of the other features described within the present disclosure can be incorporated into the method 700.

Certain embodiments are described herein as including logic or a number of components or mechanisms. Components may constitute either software components (e.g., code embodied (1) on a non-transitory machine-readable medium or (2) in a transmission signal) or hardware-implemented components. A hardware-implemented component is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented component that operates to perform certain operations as described herein.

In various embodiments, a hardware-implemented component may be implemented mechanically or electronically. For example, a hardware-implemented component may comprise dedicated circuitry or logic that is permanently configured (e.g., as a special-purpose processor, such as a field programmable gate array (FPGA) or an application-specific integrated circuit (ASIC)) to perform certain operations. A hardware-implemented component may also comprise programmable logic or circuitry (e.g., as encompassed within a programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) may be driven by cost and time considerations.

Accordingly, the term “hardware-implemented component” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a processor configured using software, the processor may be configured as respective different hardware-implemented components at different times. Software may accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components may be regarded as being communicatively coupled. Where multiple of such hardware-implemented components exist contemporaneously, communications may be achieved through signal transmission (e.g., over appropriate circuits and buses) that connect the hardware-implemented components. In embodiments in which multiple hardware-implemented components are configured or instantiated at different times, communications between such hardware-implemented components may be achieved, for example, through the storage and retrieval of information in memory structures to which the multiple hardware-implemented components have access. For example, one hardware-implemented component may perform an operation, and store the output of that operation in a memory device to which it is communicatively coupled. A further hardware-implemented component may then, at a later time, access the memory device to retrieve and process the stored output. Hardware-implemented components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on target data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

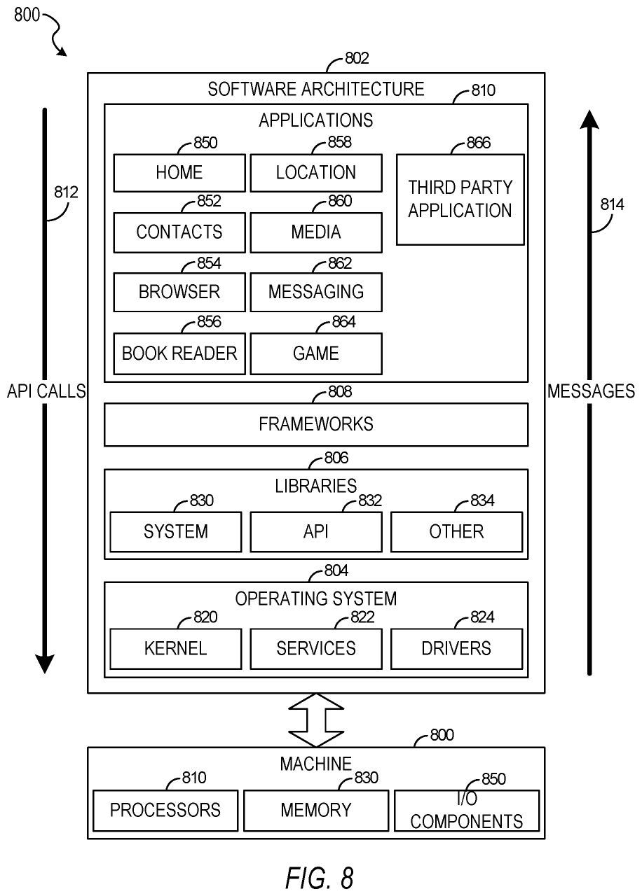

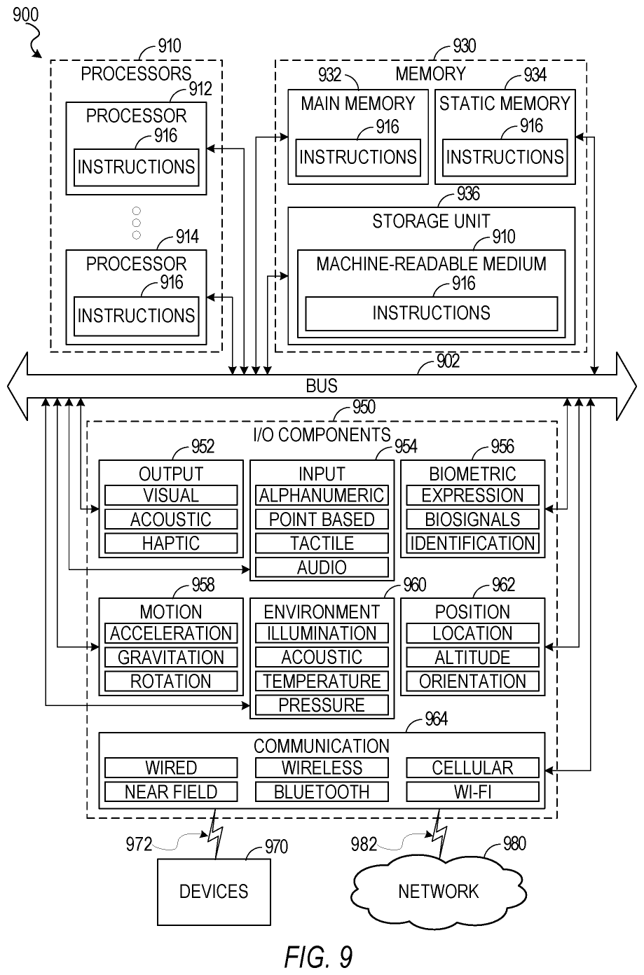

FIG. 8 is a block diagram 800 illustrating a software architecture 802, which can be installed on any one or more of the devices described above. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 810, memory 830, and input/output (I/O) components 850. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application 910, an applet, an app, or other executable code) for causing the machine 900 to perform any one or more of the methodologies discussed herein may be executed. For example, the instructions 916 may cause the machine 900 to execute the method 700 of FIG. 6. Additionally, or alternatively, the instructions 916 may implement FIGS. 1-7, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors 912 (sometimes referred to as “cores”) that may execute instructions 916 contemporaneously. Although FIG. 9 shows multiple processors 910, the machine 900 may include a single processor 912 with a single core, a single processor 912 with multiple cores (e.g., a multi-core processor), multiple processors 910 with a single core, multiple processors 910 with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine 900 will depend on the type of machine 900. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

The various memories (i.e., 930, 932, 934, and/or memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to the processors 910. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by a computer system having a memory and at least one hardware processor, the computer-implemented method comprising:
training a classification model using training data, the training data comprising a plurality of reference entity pairs, a label for each reference entity pair in the plurality of reference entity pairs, reference entity features for each reference entity pair in the plurality of reference entity pairs, and a reference context feature for each reference entity pair in the plurality of reference entity pairs, each reference entity pair in the plurality of reference entity pairs comprising a first reference entity and a second reference entity, the label identifying a type of relationship between the first reference entity and the second reference entity, the reference entity features comprising a first reference embedding of the first reference entity and a second reference embedding of the second reference entity, and the reference context feature comprising a reference sentence embedding of a reference sentence that includes the first reference entity and the second reference entity;
preparing target data, the target data comprising a plurality of target entity pairs, target entity features for each target entity pair in the plurality of target entity pairs, and a target context feature for each target entity pair in the plurality of target entity pairs, each target entity pair in the plurality of target entity pairs comprising a first target entity and a second target entity, the target entity features comprising a first target embedding of the first target entity and a second target embedding of the second target entity, and the target context feature comprising a target sentence embedding of a target sentence that includes the first target entity and the second target entity, the preparing of the target data comprising:
for each target entity pair in a plurality of target entity pairs, including the target entity pair in the target data based on a determination that the first target entity and the second target entity of the target entity pair are present in the target sentence; and
generating a target taxonomy graph using the trained classification model, the target taxonomy graph comprising a hierarchical structure, the generating the target taxonomy graph comprising inputting the target data into the trained classification model.

2. The computer-implemented method of claim 1, further comprising preparing the training data, the preparing the training data comprising:
extracting the plurality of reference entity pairs from a seed taxonomy graph of the online service;
for each reference entity pair in the plurality of reference entity pairs, extracting a first description of the first reference entity of the reference entity pair from a first data source and a second description of the second reference entity of the reference entity pair from a second data source; and
for each reference entity pair in the plurality of reference entity pairs, generating the reference sentence using the first description of the first reference entity of the reference entity pair and the second description of the second reference entity of the reference entity pair.

3. The computer-implemented method of claim 1, further comprising preparing the training data, the preparing the training data comprising:
extracting the plurality of reference entity pairs from a seed taxonomy graph of the online service;
for each reference entity pair in the plurality of reference entity pairs, assigning the label for the reference entity pair based on the type of relationship between the first reference entity and the second reference entity of the reference entity pair; and
for each reference entity pair in the plurality of reference entity pairs, classifying the reference entity pair as a positive example if the type of relationship between the first reference entity and the second reference entity of the reference entity pair comprises a parent-child relationship or a child-parent relationship, and classifying the reference entity pair as a negative example if the type of relationship between the first reference entity and the second reference entity of the reference entity pair does not comprise a parent-child relationship or a child-parent relationship.

4. The computer-implemented method of claim 1, further comprising preparing the training data, the preparing the training data comprising:
extracting the plurality of reference entity pairs from a seed taxonomy graph of the online service;
for each reference entity pair in the plurality of reference entity pairs, assigning the label for the reference entity pair based on the type of relationship between the first reference entity and the second reference entity of the reference entity pair;
for each reference entity pair in the plurality of reference entity pairs, classifying the reference entity pair as a positive example or as a negative example; and
including the plurality of reference entity pairs in the training data based on a determination that a number of the plurality of reference entity pairs that are classified as negative examples compared to a number of the plurality of reference entity pairs that are classified as positive examples satisfies a balanced data criteria.

5. The computer-implemented method of claim 1, further comprising preparing the training data, the preparing the training data comprising computing the reference sentence embeddings by inputting the reference sentences into a representation model, the representation model comprising a transformer architecture.

6. The computer-implemented method of claim 5, wherein the transformer architecture comprises a Bidirectional Encoder Representations from Transformers (BERT) model architecture.

7. The computer-implemented method of claim 1, wherein:
the first reference entity comprises a first reference skill;
the second reference entity comprises a second reference skill;
the first target entity comprises a first target skill; and
the second target entity comprises a second target skill.

8. The computer-implemented method of claim 1, wherein:
the reference entity features further comprise a reference measure of similarity between the first reference embedding of the first reference entity and the second reference embedding of the second reference entity; and
the target entity features further comprise a target measure of similarity between the first target embedding of the first target entity and the second target embedding of the second target entity.

9. The computer-implemented method of claim 1, wherein:
the reference sentence has been extracted from a reference job posting published on the online service, a reference profile published on the online service, a reference post of a user published on the online service, a reference course description published on the online service, a reference search query submitted to a search engine of the online service, or a reference description of the first reference entity or the second reference entity; and
the target sentence has been extracted from a target job posting published on the online service, a target profile published on the online service, a target post of the user published on the online service, a target course description published on the online service, a target search query submitted to the search engine of the online service, or a target description of the first target entity or the second target entity.

10. The computer-implemented method of claim 1, further comprising using the target taxonomy graph in an application of an online service.

11. The computer-implemented method of claim 10, wherein the using the target taxonomy graph in the application of the online service comprises:
receiving a search query submitted by a user of the online service via a computing device, the search query comprising the first target entity of one of the plurality of target entity pairs;
determining that the second target entity of the one of the plurality of target entity pairs is directly connected to the first target entity of the one of the plurality of target entity pairs in the target taxonomy graph;
identifying content associated with the second target entity of the one of the plurality of target entity pairs; and
displaying the identified content on the computing device as a response to the received search query.

12. The computer-implemented method of claim 10, wherein the using the target taxonomy graph in the application of the online service comprises:
determining that a first target entity of one of the plurality of target entity pairs is included in profile data of a user of the online service;
determining that the second target entity of the one of the plurality of target entity pairs is directly connected to the first target entity of the one of the plurality of target entity pairs in the target taxonomy graph;
identifying content associated with the second target entity of the one of the plurality of target entity pairs; and
displaying the identified content on a computing device of the user.

13. A system comprising:
at least one hardware processor; and
a non-transitory machine-readable medium embodying a set of instructions that, when executed by the at least one hardware processor, cause the at least one hardware processor to perform operations, the operations comprising:
training a classification model using training data, the training data comprising a plurality of reference entity pairs, a label for each reference entity pair in the plurality of reference entity pairs, reference entity features for each reference entity pair in the plurality of reference entity pairs, and a reference context feature for each reference entity pair in the plurality of reference entity pairs, each reference entity pair in the plurality of reference entity pairs comprising a first reference entity and a second reference entity, the label identifying a type of relationship between the first reference entity and the second reference entity, the reference entity features comprising a first reference embedding of the first reference entity and a second reference embedding of the second reference entity, and the reference context feature comprising a reference sentence embedding of a reference sentence that includes the first reference entity and the second reference entity;
preparing target data, the target data comprising a plurality of target entity pairs, target entity features for each target entity pair in the plurality of target entity pairs, and a target context feature for each target entity pair in the plurality of target entity pairs, each target entity pair in the plurality of target entity pairs comprising a first target entity and a second target entity, the target entity features comprising a first target embedding of the first target entity and a second target embedding of the second target entity, and the target context feature comprising a target sentence embedding of a target sentence that includes the first target entity and the second target entity, the preparing of the target data comprising:
for each target entity pair in a plurality of target entity pairs, including the target entity pair in the target data based on a determination that the first target entity and the second target entity of the target entity pair are present in the target sentence; and
generating a target taxonomy graph using the trained classification model, the target taxonomy graph comprising a hierarchical structure, the generating the target taxonomy graph comprising inputting the target data into the trained classification model.

14. The system of claim 13, wherein the operations further comprise preparing the training data, the preparing the training data comprising:
extracting the plurality of reference entity pairs from a seed taxonomy graph of the online service;
for each reference entity pair in the plurality of reference entity pairs, extracting a first description of the first reference entity of the reference entity pair from a first data source and a second description of the second reference entity of the reference entity pair from a second data source; and
for each reference entity pair in the plurality of reference entity pairs, generating the reference sentence using the first description of the first reference entity of the reference entity pair and the second description of the second reference entity of the reference entity pair.

15. The system of claim 13, wherein the operations further comprise preparing the training data, the preparing the training data comprising:
extracting the plurality of reference entity pairs from a seed taxonomy graph of the online service;
for each reference entity pair in the plurality of reference entity pairs, assigning the label for the reference entity pair based on the type of relationship between the first reference entity and the second reference entity of the reference entity pair; and
for each reference entity pair in the plurality of reference entity pairs, classifying the reference entity pair as a positive example if the type of relationship between the first reference entity and the second reference entity of the reference entity pair comprises a parent-child relationship or a child-parent relationship, and classifying the reference entity pair as a negative example if the type of relationship between the first reference entity and the second reference entity of the reference entity pair does not comprise a parent-child relationship or a child-parent relationship.

16. The system of claim 13, wherein the operations further comprise preparing the training data, the preparing the training data comprising:
extracting the plurality of reference entity pairs from a seed taxonomy graph of the online service;
for each reference entity pair in the plurality of reference entity pairs, assigning the label for the reference entity pair based on the type of relationship between the first reference entity and the second reference entity of the reference entity pair;
for each reference entity pair in the plurality of reference entity pairs, classifying the reference entity pair as a positive example or as a negative example; and
including the plurality of reference entity pairs in the training data based on a determination that a number of the plurality of reference entity pairs that are classified as negative examples compared to a number of the plurality of reference entity pairs that are classified as positive examples satisfies a balanced data criteria.

17. The system of claim 13, wherein the operations further comprise preparing the training data, the preparing the training data comprising computing the reference sentence embeddings by inputting the reference sentences into a representation model, the representation model comprising a transformer architecture.

18. The system of claim 17, wherein the transformer architecture comprises a Bidirectional Encoder Representations from Transformers (BERT) model architecture.

19. The system of claim 13, wherein:
the first reference entity comprises a first reference skill;
the second reference entity comprises a second reference skill;
the first target entity comprises a first target skill; and
the second target entity comprises a second target skill.

20. A non-transitory machine-readable medium embodying a set of instructions that, when executed by at least one hardware processor, cause the at least one hardware processor to perform operations, the operations comprising:
training a classification model using training data, the training data comprising a plurality of reference entity pairs, a label for each reference entity pair in the plurality of reference entity pairs, reference entity features for each reference entity pair in the plurality of reference entity pairs, and a reference context feature for each reference entity pair in the plurality of reference entity pairs, each reference entity pair in the plurality of reference entity pairs comprising a first reference entity and a second reference entity, the label identifying a type of relationship between the first reference entity and the second reference entity, the reference entity features comprising a first reference embedding of the first reference entity and a second reference embedding of the second reference entity, and the reference context feature comprising a reference sentence embedding of a reference sentence that includes the first reference entity and the second reference entity;
preparing target data, the target data comprising a plurality of target entity pairs, target entity features for each target entity pair in the plurality of target entity pairs, and a target context feature for each target entity pair in the plurality of target entity pairs, each target entity pair in the plurality of target entity pairs comprising a first target entity and a second target entity, the target entity features comprising a first target embedding of the first target entity and a second target embedding of the second target entity, and the target context feature comprising a target sentence embedding of a target sentence that includes the first target entity and the second target entity, the preparing of the target data comprising:
for each target entity pair in a plurality of target entity pairs, including the target entity pair in the target data based on a determination that the first target entity and the second target entity of the target entity pair are present in the target sentence; and
generating a target taxonomy graph using the trained classification model, the target taxonomy graph comprising a hierarchical structure, the generating the target taxonomy graph comprising inputting the target data into the trained classification model.
